(19) United States
(12) Patent Application Publication
(10) Pub. No.: US 2006/0281766 A1
(43) Pub. Date: Dec. 14, 2006

(54) Fungicidal mixtures

(76) Inventors: Jordi Tormo I Blasco, Weinheim (DE); Thomas Grote, Wachenhein (DE); Maria Scherer, Godramstein (DE); Reinhard Stierl, Freinsheim (DE); Sigfried Strathmann, Limburgerhof (DE); Ulrich Schofl, Bruhl (DE); Egon Haden, Kleinniedesheim (DE); Manfred Hampel, Neustadt (DE)

Correspondence Address: BIRCH STEWART KOLASCH & BIRCH, PO BOX 747, FALLS CHURCH, VA, 22040-0747, US

(21) Appl. No.: 10/556,162

(22) PCT Filed: May 15, 2004
(86) PCT No.: PCT/EP04/05250

§ 371 Date: Nov. 9, 2005

(30) Foreign Application Priority Data
May 22, 2003 (DE) 103237089
Jul. 16, 2003 (DE) 103324305
Mar. 30, 2004 (DE) 1020040160848

(51) Int. Cl. A01N 43/90; A01N 37/18

(52) U.S. Cl. 514/259.31; 514/615

(57) ABSTRACT

Fungicidal mixtures, comprising, as active components,
1) dimoxystrobin of the formula I 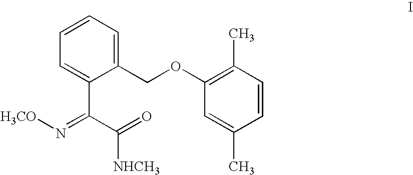 and
2) the compound of the formula II 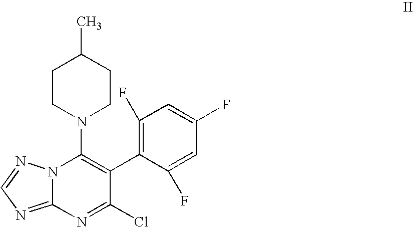 in a synergistically effective amount, methods for controlling harmful fungi using mixtures of the compound I with the compound II, the use of the compounds I and II for preparing such mixtures and compositions comprising these mixtures are described.

The present invention relates to fungicidal mixtures, comprising, as active components,
1) dimoxystrobin of the formula I 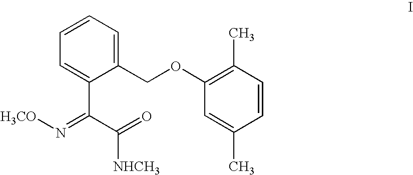
and
2) the compound of the formula II 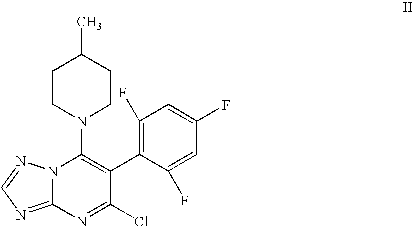
in a synergistically effective amount.

Moreover, the invention relates to a method for controlling harmful fungi using mixtures of the compound I with the compound II and to the use of the compound I with the compound II for preparing such mixtures and to compositions comprising these mixtures.

The compound of the formula I belongs to the class of the active strobilurin compounds. Their preparation and their action against harmful fungi are known (common name: dimoxystrobin; EP-A 477 631).

EP-A 645 087, EP-A 645 088, EP-A 645 089, EP-A 645 090, EP-A 645 091 and EP-A 648 417 disclose mixtures of the compound I with other active compounds.

The compound II, 5-chloro-7-(4-methylpiperidin-1-yl)-6-(2,4,6-trifluorophenyl)-[1,2,4]tri-azolo[1,5-a]pyrimidine, its preparation and its action against harmful fungi are likewise known from the literature (WO 98/46607).

Mixtures of triazolopyrimidines with strobilurin derivatives are known in a general manner from EP-A 988 790. The compounds I and II are embraced by the general disclosure of this application, but neither strobilurin I nor triazolopyrimidine II are mentioned in EP-A 988 790.

The fungicidal action of the known mixtures is not always entirely satisfactory. For example, the active triazolopyrimidine compounds known from the application mentioned above are not suitable for controlling harmful fungi from the class of the Oomycetes. Also, the action of the strobilurin derivative I against Oomycetes does not meet today's requirements.

It is an object of the present invention to provide, with a view to reducing the application rates and to broaden the activity spectrum of the known compounds, mixtures which, at a reduced total amount of active compounds applied, have improved action against harmful fungi, in particular against those from the class of the Oomycetes.

We have found that this object is achieved by the mixtures defined at the outset. Moreover, we have found that simultaneous, that is joint or separate, application of the compound I and the compound II or successive application of the compound I and the compound II allows better control of harmful fungi than is possible with the individual compounds.

The mixtures of the compound I and the compound II, or the compound I and the compound II used simultaneously, that is jointly or separately, are distinguished by outstanding activity against a broad spectrum of phytopathogenic fungi, in particular from the classes of the Ascomycetes, Deuteromycetes, Oomycetes and Basidiomycetes. Particularly advantageously, they are used for controlling Oomycetes. Some of them act systemically and can be used in crop protection as foliar- and soil-acting fungicides.

They are especially important for controlling a large number of fungi on a variety of crop plants, such as bananas, cotton, vegetable species (for example cucumbers, beans and cucurbits), barley, grass, oats, coffee, potatoes, corn, fruit species, rice, rye, soybean, tomatoes, grapevine, wheat, ornamentals, sugarcane and a large number of seeds.

In addition, the combination according to the invention of the compounds I and II is also suitable for controlling other pathogens, such as, for example, Septoria and Puccinia species in cereals and Alternaria and Boytritis species in vegetables, fruit and grapevines.

They are particularly suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and grass, Ustilago species on cereals and sugarcane, Venturia inaequalis on apples, Bipolaris and Drechslera species on cereals, rice and grass, Septoria species on wheat, Botrytis cinerea on strawberries, vegetables, ornamentals and grapevines, Mycosphaerella species on bananas, groundnuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Altemaria species on vegetables and fruit and also Fusarium and Verticillium species. Particularly advantageously, they are employed for controlling Phytophthora infestans on a variety of vegetable species.

Moreover, they can be used in the protection of materials (for example the protection of wood), for example against Paecilomyces variotii.

When preparing the mixtures, it is preferred to employ the pure active compounds I and II, to which further active compounds against harmful fungi or other pests, such as insects, arachnids or nematodes, or else herbicidal or growth-regulating active compounds or fertilizers can be added as required.

Other suitable active compounds in the above sense are in particular active compounds selected from the following groups:
acylalanines, such as benalaxyl, metalaxyl, ofurace or oxadixyl,
amine derivatives, such as aldimorph, dodine, dodemorph, fenpropimorph, fenpropidin, guazatine, iminoctadine, spiroxamine or tridemorph,
anilinopyrimidines, such as pyrimethanil, mepanipyrim or cyprodinyl,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, epoxiconazole, fenbuconazole, fluquinconazole, flusilazole, flutriafol, hexaconazole, imazalil, ipcanazole, metconazole, myclobutanil, penconazole, propiconazole, prochloraz, prothioconazole, simeconazole, tebuconazole, tetraconazole, triadimefon, triadimenol, triflumizole or triticonazole,
dicarboximides, such as iprodione, myclozolin, procymidone or vinclozolin,
dithiocarbamates, such as ferbam, nabam, maneb, mancozeb, metam, metiram, propineb, polycarbamate, thiram, ziram or zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolane, mepronil, nuarimol, picobenzamide, probenazole, proquinazid, pyrifenox, pyroquilon, quinoxyfen, silthiofam, thiabendazole, thifluzamide, thiophanate-methyl, tiadinil, tricyclazole or triforine,
copper fungicides, such as Bordeaux mixture, copper acetate, copper oxychloride or basic copper sulfate,
nitrophenyl derivatives, such as binapacryl, dinocap, dinobuton or nitrophthalisopropyl,
phenylpyrroles, such as fenpiclonil or fludioxonil,
sulfur,
other fungicides, such as acibenzolar-S-methyl, benthiavalicarb, carpropamid, chlorothalonil, cyflufenamid, cymoxanil, dazomet, diclomezine, diclocymet, diethofencarb, edifenphos, ethaboxam, fenhexamid, fentin acetate, fenoxanil, ferimzone, fluazinam, phosphorous acid, fosetyl, fosetyl-aluminum, iprovalicarb, hexachlorobenzene, metrafenone, pencycuron, propamocarb, phthalide, tolclofos-methyl, quintozene or zoxamide,
strobilurins, such as atoxystrobin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet or tolylfluanid,
cinnamides and analogous compounds, such as dimethomorph, flumetover or flumorph.

In one embodiment of the mixtures according to the invention, the compounds I and II are admixed with a further fungicide III or two fungicides III and IV.

Suitable components III and IV are in particular the azoles mentioned.

Preference is given to mixtures of the compounds I and II with a component III. Particularly preferred are mixtures of the compounds I and II.

The compound I and the compound II can be applied simultaneously, that is jointly or separately, or in succession, so that the active compounds unfold their fungicidal action together. In the case of separate application, the result of the control measures is generally not affected by the order of application.

Usually, the compound I and the compound II are applied in a weight ratio of from 100:1 to 1:100, preferably from 10:1 to 1:50, in particular from 5:1 to 1:20.

The components III and IV are added to the compound I, if required, in a ratio from 20:1 to 1:20.

Depending on the type of compounds and on the desired effect, the application rates of the mixtures according to the invention are from 5 g/ha to 2000 g/ha, preferably from 50 to 1500 g/ha, in particular from 50 to 750 g/ha.

Correspondingly, the application rates of the compound I are generally from 1 to 750 g/ha, preferably from 10 to 500 g/ha, in particular from 5 to 250 g/ha.

Correspondingly, the application rates of the compound II are generally from 1 to 1000 g/ha, preferably from 10 to 750 g/ha, in particular from 20 to 500 g/ha.

In the treatment of seed, the application rates of the mixture are generally from 1 to 1000 g/100 kg of seed, preferably from 1 to 200 g/100 kg, in particular from 5 to 100 g/100 kg.

In the control of phytopathogenic harmful fungi, the separate or joint application of the compounds I and II or of the mixtures of the compounds I and II is carried out by spraying or dusting the seeds, the plants or the soils before or after sowing of the plants or before or after emergence of the plants.

The mixtures according to the invention or the compounds I and II can be converted into the customary formulations, for example solutions, emulsions, suspensions, dusts, powders, pastes and granules. The application form depends on the particular purpose; in each case, it should ensure a fine and uniform distribution of the compound according to the invention.

The formulations are prepared in a known manner, for example by extending the active compound with solvents and/or carriers, if desired using emulsifiers and dispersants. Solvents/auxiliaries which are suitable are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used.
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutyinaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ether, ethoxylated isooctylphenol, octylphenol, nonylphenol, alkylphenol polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations:

1. Products for Dilution with Water

A) Water-soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifier (Ultraturax) and made into a homogeneous emulsion. Dilution with water gives an emulsion.

E) Suspensions (SC, OD)

In an agitated ball mill, 20 parts by weight of the active compounds are comminuted with addition of dispersant, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersant, wetters and silica gel. Dilution with water gives a stable dispersion or solution of the active compound.

2. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% of carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate just immediately prior to use (tank mix). These agents can be admixed with the agents according to the invention, usually in a weight ratio of 1:10 to 10:1.

The compounds I and II or the mixtures or the corresponding formulations are applied by treating the harmful fungi or the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal action of the compound and the mixtures can be demonstrated by the experiments below:

The active compounds, separately or jointly, were prepared as a stock solution with 0.25% by weight of active compound in acetone or DMSO. 1% by weight of the emulsifier Uniperol® EL (wetting agent having emulsifying and dispersing action based on ethoxylated alkylphenols) was added to this solution, and the solution was diluted with water to the desired concentration.

Use example—activity against late blight on tomatoes caused by Phytophthora infestans

Leaves of potted plants of the cultivar “Groβe Fleischtomate St. Pierre” were sprayed to runoff point with an aqueous suspension having the concentration of active compounds stated below. The next day, the leaves were infected with a cold aqueous zoospore suspension of Phytolohthora infestans having a density of 0.25×10⁶ spores/ml. The plants were then placed in a water-vapor-saturated chamber at 18-20° C. After 6 days, the late blight on the untreated, but infected control plants had developed to such an extent that the infection could be determined visually in %.

The visually determined percentages of infected leaf areas were converted into efficacies in % of the untreated control:

The efficacy (E) is calculated as follows using Abbot's formula:
E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of the mixtures of active compounds were determined using Colby's formula [S. R. Colby, (Calculating synergistic and antagonistic responses of herbicide combinations), Weeds 15, 20-22 (1967)] and compared with the observed efficacies.
Colby's formula:
   E=x+y−x·y/100
E expected efficacy, expressed in % of the untreated control, when using the mixture of the active compounds A and B at the concentrations a and b
x efficacy, expressed in % of the untreated control, when using active compound A at the concentration a
y efficacy, expressed in % of the untreated control, when using active compound B at the concentration b

The comparative compounds used were compounds A and B, known from the mixtures described in EP-A 988 790:

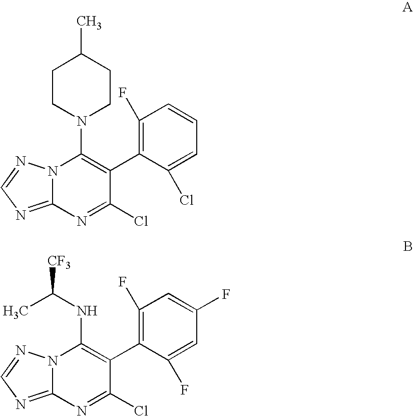

TABLE A
Individual active compounds

| | | Concentration of | |
|---|---|---|---|
| | | active compound | |
| | | in the spray | Efficacy in % of the |
| Example | Active compound | liquor [ppm] | untreated control |
| 1 | — | Control (untreated) | (90% infection) |
| 2 | I | 1 | 56 |
| | (dimoxystrobin) | 0.25 | 0 |
| 3 | II | 16 | 0 |
| | | 0.25 | 0 |
| 4 | Comparative | 16 | 0 |
| | compound A | 0.25 | 0 |
| 5 | Comparative | 16 | 0 |
| | compound B | 0.25 | 0 |

TABLE B
Mixtures according to the invention

| | Mixture of active compounds | | |
|---|---|---|---|
| | Concentration | Observed | Calculated |
| Example | Mixed ratio | efficacy | efficacy*) |
| 6 | I + II | 94 | 56 |
| | 1 + 16 ppm | | |
| | 1:16 | | |
| 7 | I + II | 67 | 0 |
| | 0.25 + 0.25 ppm | | |
| | 1:1 | | |
| 8 | I + II | 78 | 56 |
| | 1 + 0.25 ppm | | |
| | 4:1 | | |

*)efficacy calculated using Colby's formula

TABLE C
Comparative experiments

| | Mixture of active compounds | | |
|---|---|---|---|
| | Concentration | Observed | Calculated |
| Example | Mixed ratio | efficacy | efficacy*) |
| 9 | I + A | 11 | 56 |
| | 1 + 16 ppm | | |
| | 1:16 | | |
| 10 | I + A | 0 | 0 |
| | 0.25 + 0.25 ppm | | |
| | 1:1 | | |
| 11 | I + A | 11 | 56 |
| | 1 + 0.25 ppm | | |
| | 4:1 | | |
| 12 | I + B | 56 | 56 |
| | 1 + 16 ppm | | |
| | 1:16 | | |
| 13 | I + B | 0 | 0 |
| | 0.25 + 0.25 ppm | | |
| | 1:1 | | |
| 14 | I + B | 33 | 56 |
| | 1 + 0.25 ppm | | |
| | 4:1 | | |

*)efficacy calculated using Colby's formula

The test results show that in all mixing ratios the observed efficacy of the mixtures according to the invention is considerably higher than that predicted using Colby's formula, whereas the mixtures of the comparative compounds show no synergism.

1. A fungicidal mixture, comprising
1) dimoxystrobin of the formula I 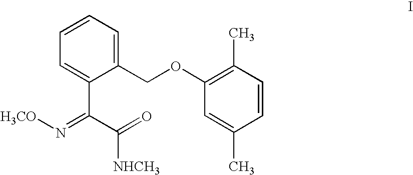
and
2) the compound of the formula II 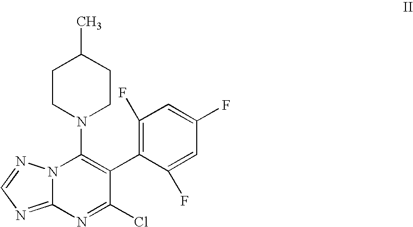
in a synergistically effective amount.

2. A fungicidal mixture, comprising the compound of the formula I and the compound of the formula II as set forth in claim 1, in a weight ratio of from 100:1 to 1:100.

3. The fungicidal mixture as claimed in claim 1, additionally comprising an active compound III selected from the group consisting of bitertanol, bromoconazole, cyproconazole, difenoconazole, dinitroconazole, epoxiconazole, fenbuconazole, fluquinconazole, flusilazole, flutriafole, hexaconazole, imazalil, ipconazole, metconazole, myclobutanil, penconazole, propiconazole, prochloraz, prothioconazole, simeconazole, tebuconazole, tetraconazole, triademefon, triadimenole, triflumizole and triticonazole.

4. A fungicidal composition, comprising a liquid or solid carrier and a mixture as claimed in claim 1.

5. A method for controlling harmful fungi, which comprises treating the fungi, their habitat or the seed, the soil, the plants or the materials to be protected against fungal attack with a synergistically effective amount of the compound I and the compound II as set forth in claim 1.

6. A method for controlling harmful fungi, which comprises treating the fungi, their habitat or the seed, the soil, the plants or the materials to be protected against fungal attack with a synergistically effective amount of the compound I and the compound II as set forth in claim 1, wherein the compounds I and II are applied simultaneously, that is jointly or separately, or in succession.

7. A method for controlling harmful fungi, which comprises treating the fungi, their habitat or the seed, the soil, the plants or the materials to be protected against fungal attack with a synergistically effective amount of the compound I and the compound II as set forth in claim 1, wherein the mixture is applied in an amount of from 5 g/ha to 2000 g/ha.

8. A method for controlling harmful fungi, which comprises treating the fungi, their habitat or the seed, the soil, the plants or the materials to be protected against fungal attack with a synergistically effective amount of the compound I and the compound II as set forth in claim 1, wherein the mixture is applied in an amount of from 1 to 1000g/100 kg of seed.

9. The method as claimed in claim 5, wherein the harmful fungi to be controlled are from the class of the Oomycetes.

10. Seed, comprising the mixture as claimed in claim 1 in an amount of from 1 to 1000 g/100 kg.

11. Use of the compound I and the compound II as set forth in claim 1 for preparing a composition suitable for controlling harmful fungi.

12. The fungicidal mixture as claimed in claim 2, additionally the fungicidal mixture as claimed in claim 1, additionally comprising an active compound III selected from the group consisting of bitertanol, bromoconazole, cyproconazole, difenoconazole, dinitroconazole, epoxiconazole, fenbuconazole, fluquinconazole, flusilazole, flutriafole, hexaconazole, imazalil, ipconazole, metconazole, myclobutanil, penconazole, propiconazole, prochloraz, prothioconazole, simeconazole, tebuconazole, tetraconazole, triademefon, triadimenole, triflumizole and triticonazole.

13. A fungicidal composition, comprising a liquid or solid carrier and a mixture as claimed in claim 2.

14. A fungicidal composition, comprising a liquid or solid carrier and a mixture as claimed in claim 3.

15. A method for controlling harmful fungi, which comprises treating the fungi, their habitat or the seed, the soil, the plants or the materials to be protected against fungal attack with a synergistically effective amount of the compound I and the compound II as set forth in claim 2, wherein the mixture is applied in an amount of from 5 g/ha to 2000 g/ha.

16. A method for controlling harmful fungi, which comprises treating the fungi, their habitat or the seed, the soil, the plants or the materials to be protected against fungal attack with a synergistically effective amount of the compound I and the compound II as set forth in claim 3, wherein the mixture is applied in an amount of from 5 g/ha to 2000 g/ha.

17. A method for controlling harmful fungi, which comprises treating the fungi, their habitat or the seed, the soil, the plants or the materials to be protected against fungal attack with a synergistically effective amount of the compound I and the compound II as set forth in claim 2, wherein the mixture is applied in an amount of from 1 to 1000 g/100 ka of seed.

18. A method for controlling harmful fungi, which comprises treating the fungi, their habitat or the seed, the oil, the plants or the materials to be protected against fungal attack with a synergistically effective amount of the compound I and the compound II as set forth in claim 3, wherein the mixture is applied in an amount of from 1 to 1000 g/100 kg of seed.

19. The method as claimed in claim 6, wherein the harmful fungi to be controlled are from the class of the Oomycetes.

20. The method as claimed in claim 7, wherein the harmful fungi to be controlled are from the class of the Oomycetes.
